(19) United States
(12) Patent Application Publication
(10) Pub. No.: US 2003/0123714 A1
(43) Pub. Date: Jul. 3, 2003

(54) Method and system for capturing fingerprints from multiple swipe images

(76) Inventors: Lawrence O'Gorman, Madison, NJ (US); Xiongwu Xia, Dayton, NJ (US)

Correspondence Address: PATENT COUNSEL, Veridicom, Inc., 1248 Reamwood Ave., Sunnyvale, CA, 94089, US

(21) Appl. No.: 10/288,554

(22) Filed: Nov. 4, 2002

Related U.S. Application Data
(60) Provisional application No. 60/337,933, filed on Nov. 6, 2001.

(51) Int. Cl. G06K 9/00; G06K 9/36; G06K 9/64

(52) U.S. Cl. 382/124; 382/284; 382/278

(57) ABSTRACT

Slices of image data are collected and frames of image data within the slices are compared and used to determine the overlap between slices so that full images may be reconstructed. Slice and frame image correlation methods are also used to compensate for image stretch. Slice and frame correlation techniques are disclosed that may be used to determine swipe start, swipe stop and swipe too fast conditions as well as anti-spoof techniques.

### CROSS REFERENCE TO RELATED APPLICATIONS

This application is related to U.S. Provisional Application Serial No. 60/337,933 filed Nov. 6, 2001, entitled, “Method and System For Capturing Fingerprints From Multiple Swipe Images”, which is incorporated herein by reference in its entirety and to which priority is claimed.

### CROSS REFERENCE TO APPENDIX

Appendix A, which is part of the present disclosure, consists of 14 pages of a software program operable on a host computer in accordance with embodiments of the present invention. These 14 pages correspond to pages A-10 to A-23 of the provisional application Ser. No. 60/337,933 filed Nov. 6, 2001. A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

Embodiments of the invention relate systems and methods for the reading data from biometric elements, such as fingerprints, used especially in devices for authenticating individuals.

2. Background

Numerous biometric authentication systems have been developed. One way that the systems can be categorized is based upon the manner in which the fingerprint or other biometric image to be authenticated is collected. In general, there are two broad categories based upon whether the biometric object moves or is stationary relative to the sensor. Authentication systems where the biometric object moves relative to a sensor are called swipe sensors.

In swipe systems for fingerprint authentication, fingerprint image data is collected from a sensor as a finger is passed over an image capture window of the sensor. The sensor and associated systems are designed to collect a series of images as the finger passes over the sensor capture window. As a result of image capture programs, sensor output data is collected. A processing algorithm of the fingerprint authentication system is needed to position the series of images so that original image can be reconstituted from the collected image data.

One challenge facing all swipe sensor systems is how to assemble the collected partial fingerprint images or slices into a fingerprint image that may be compared to the enrolled fingerprint. Inherent in swipe sensors is image variation caused by the relative speed of the finger and the sensor. Some existing swipe systems, such as that described in U.S. Pat. No. 6,459,804, detail image processing methods that assume a constant finger speed. As swipe sensors find more widespread uses, more robust methods of image processing are required to provide accurate authentication.

Therefore, what is needed is an improved method and system for processing swipe image data that can more accurately compensate for various swipe speeds as well as methods to determine and compensate for image variation as a result of swipe speed.

### SUMMARY OF THE INVENTION

Embodiments of the invention generally provide:

A method for reconstructing two overlapping images, comprising: collecting a first slice of image data; collecting a second slice of image data; determining the correlation factors for a plurality of frames of image data within the first slice; determining the correlation factors for a frame of image data within the second slice; comparing the correlation factors from each of the plurality of frames of image data from the first slice to the correlation factors for the frame of image data from the second slice; determining the frame within the first slice with the highest correlation to the frame from the second slice; and positioning the first slice of image data relative to the second slice of image data based upon the location of the frame within the first slice with the highest correlation to the frame from the second slice.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

Other features of the invention shall appear from the detailed description of the following embodiments, this description being made with reference to the appended drawings, of which:

FIG. 1 shows a general system view of the fingerprint sensor;

FIG. 2 shows an array of sensitive elements in a biometric sensor;

FIG. 3 shows a block diagram of an exemplary embodiment of a fingerprint reading system according to the invention;

FIG. 4 shows slices of image data representing slice collection when shift is constant;

FIG. 5 shows slices of image data representing slice collection when shift is “too fast”;

FIGS. 6 shows slices of image data representing slice collection when shift is increasing; and

FIGS. 7 shows slices of image data representing slice collection when shift is decreasing;

To facilitate understanding, identical reference numerals have been used, wherever possible, to designate identical elements that are common to the figures.

### DETAILED DESCRIPTION OF THE PREFERRED EMBODIMENT

System Overview and Sensor Description

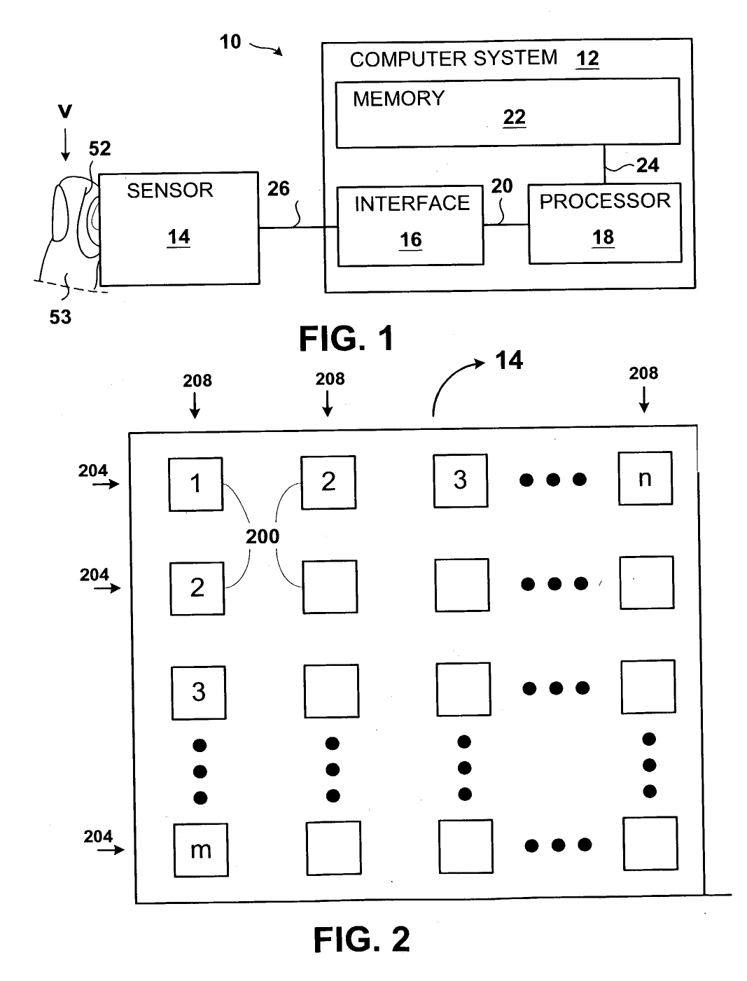

FIG. 1 illustrates a personal verification system 10 that may be used to implement embodiments of the present invention. Personal verification system 10 includes a biometric sensor 14 coupled to a computer system 12 via bus 26. Computer system 12 includes an interface 16, a processor 18 connected to interface 16 by an interface-processor bus 20 and a memory 22 connected to processor 18 by a bus 24. Memory 22 could be one or a plurality of electronic storage devices.

Computer system 12 generically represents any type of computer system, such as a microprocessor-based system, a mainframe system, or any other type of general or special purpose computing system that includes an interface, a processor and memory. Processor 18 is any type of processor, such as a microprocessor, dedicated logic, a digital signal processor, a programmable gate array, a neural network, or a central processor unit implemented in any other technology. Although FIG. 1 illustrates processor 18 and sensor 14 as separate and distinct components, one skilled in the art will appreciate that processor 18 can be integrated with sensor 14. Moreover, it is also to be appreciated that the separate components of computer system 12 could also be combined or integrated into a single device. In addition, although only one biometric sensor is shown in FIG. 1, any number of such sensors can be connected to computer 12 in any combination, enabling various biometric features from one or more users to be used.

Biometric sensor 14 is coupled to computer system 12 via an input-output line 16. Alternatively, biometric sensor 14 can be integrated in computer system 12. Biometric sensor 14 produces a representation of a biometric feature, such as a fingerprint, palm print, retinal image, facial feature, signature or other biometric attribute or characteristic. While embodiments of the present invention may be used with any type of biometric feature, for purposes of discussion and not limitation, embodiments of the present invention will be described with regard to processing a fingerprint image. FIG. 1 illustrates an example where the biometric object is a finger 53 and the biometric element to be measured is fingerprint 52. Finger 53 moves in direction V relative to sensor 14. It could also be said that finger 53 is swiping across sensor 14 in direction V.

It is to be appreciated however that embodiments of the methods of the present invention may also be applied to processing other kinds of biometric data. In general, a fingerprint-reading sensor has a matrix of sensitive elements organized in rows and columns, giving a signal that differs depending on whether a ridge of the fingerprint line touches or does not touch a sensitive element of the sensor. Several patents have been filed on various means of reading fingerprints such as U.S. Pat. No. 4,353,056 that describes a principle of reading based on the capacitance of the sensitive elements of the sensor. Other systems comprise sensors having components sensitive to pressure, temperature or else to pressure and temperature converting the spatial information of pressure and/or temperature into an electric signal that is then collected by a semiconductor-based multiplexer which may for example be a charge coupled device (CCD) matrix. The U.S. Pat. No. 4,394,773 describes a principle of this kind.

The sensors based on the piezoelectric and/or pyroelectric effects are useful because they are sensitive to pressure and/or to heat exerted on their sensitive elements. This feature makes it possible to ascertain, during the reading of fingerprints, that the finger is truly part of a living individual through the inherent heat that it releases. It is also possible to detect the variations due to the flow of blood in the finger, inducing a variation of heat and/or pressure, thus providing for greater reliability in the authentication of the fingerprint. These and other types of biometric sensors may benefit from embodiments of the image processing methods of the present invention and are considered within the scope of the invention.

As illustrated in FIG. 2, the sensitive elements 200 within biometric sensor 14 are typically organized in rows and columns. Other arrangements of sensitive elements 200 are possible. The arrangements of specific sensitive elements 200 may vary depending upon the type of sensitive element used and the type of biometric data collected. FIG. 2 illustrates a sensor 14 with a plurality of rows 204 from row 1 to row m and plurality of columns 208 from column 1 to column n. The sensitive elements 200 of the sensor 14 may have any shape or size suited to their design but for purposes of discussion are represented as having a rectangular or square shape.

The sensitive elements 200 of the biometric sensor 14 are selected and used to detect the topography or other data of the biometric element being passed across the sensor 14. In the case where the biometric element is a finger, the sensitive elements 200 of the sensor 14 are used to pick up the matrix pattern of sensitive element output signals created by the ridges and hollows of a finger sliding on the surface of the sensor 14. The matrix pattern of the sensitive element output signals are converted by the sensor 14 into electric signals that correspond to a part of the finger at a given point in time in its relative shift on the sensor 14. The individual sensitive elements 200 typically have dimensions smaller than the biometric object under investigation. When used as a fingerprint sensor, the sensitive elements 200 should have dimensions that are smaller than the ridges and valleys of a finger. While the present invention will be described in terms of a fingerprint sensor, one of ordinary skill in the art will recognize that the invention is more generally applicable to the detection of biometric feature variations in other biometric objects in addition to fingerprints. In such cases, the dimensions of the sensing elements should be chosen as appropriate for the selected biometric object or objects and variations in those objects.

Embodiments of the present invention will be described with regard to an array of sensitive elements 200 within biometric sensor 14. It is to be appreciated that the sensitive elements 200 within biometric sensor 14 can be any of a wide variety of element types used to detect a biometric feature including, capacitive sensor elements, a camera, visual or optical elements, an active energy element such as a laser beam and receiver element sensor, piezoelectric elements, pressure elements or other biometric sensors comprising combinations of any of the above described sensitive elements. Examples of biometric sensors are described in U.S. Pat. No. 6,016,355, entitled, “Capacitive Fingerprint Acquisition Sensor;” U.S. Pat. No. 6,049,620, entitled, “Capacitive Fingerprint Sensor with Adjustable Gain;” U.S. Pat. No. 6,330,345, entitled, “Automatic Adjustment Processing for Sensor Devices;” and U.S. Pat. application Ser. No. 09/300,087, entitled, “Method for Imaging Fingerprints and Concealing Latent Fingerprints”, filed Apr. 26, 1999. All four applications are commonly owned with the present application and are herein incorporated by reference.

Slice and Frame

A slice and a frame will now be defined with reference to FIG. 2. FIG. 2 shows sensor 14 having an array of sensitive elements 200 arranged in rows and columns. A slice as used herein is a collection of outputs from an entire sensor array of sensitive elements or, alternatively, a subset of sensitive elements from an entire sensitive element array. A frame is a subset of output signals selected from the slice outputs. In this manner a slice will always comprise a larger array of sensitive elements than a frame. The overall sensor size may be an array of sensitive elements with 32 rows and 256 columns. For example, a slice for that system may comprise the outputs from an array of 256 columns and 28 rows of sensitive elements. Another sensor may have an array of sensitive elements having 256 columns and 60 rows. A slice within that sensor may comprise, for example, 20 rows of sensitive elements. A frame within that exemplary slice may comprise 256 columns and 6 rows of sensitive elements.

The use of a slice of output signals provides for more robust sensor operation. For example, consider a sensor with 60 rows and 256 columns of sensitive elements. Consider further the case where the slice height is 20 rows. In this sensor, multiple slice positions may be designated either by the sensor system software or hardware. For example, the sensor system may first designate that the initial slice used by the system will be the first 20 rows of the sensor. If, during the life of the sensor, some sensitive elements fail, or if a number of sensitive elements fail within the selected slice, then the sensor control system would simply select another group of 20 rows of sensitive elements and the sensor remains in service. Similarly, at the conclusion of the sensor manufacturing process, if some sensitive elements within the designated sensor array do not function properly, then another slice of the sensor array may be designated where there are sufficient functional sensitive elements. In this manner, the ability to flexibly assign slices makes it more likely that a sensor may be put into service or remain in service rather than be scrapped or returned for repair.

Sensor system application may determine the relationship between the frame size and the slice size because accuracy of identification generally increases as more sensitive elements are compared between slices. The frame size may also be selected based upon an applications relative need for increased accuracy. While desiring not to be constrained by theory, it is believed that a frame comprising a larger number of sensitive elements relative to the number of sensitive elements in the slice will provide a more statistically accurate authentication method. Consider now sensor used in a low security product where valid authentication is not critical. One example would be where a biometric sensor is used to make a toy doll speak. In this case, the sensor need not verify the identity of a user but simply detect the presence of a user in order to activate the doll speech routine. In this type of example, the frame size relative to the slice size could be small but still achieve a satisfactory result. For example, a slice size of 30 rows and a frame size of 6 rows. In this case, 6 rows of frame data are being compared to find correlating frames between slices.

On the other hand, in a high security authentication application a higher statistical probability of accurate authentication is required. One representative high security application is using a biometric sensor to provide access to a bank account. In this case, a larger frame to slice ratio is desired. For example, consider the same 30 row slice above but instead of only 6 rows use, for example, 15 rows in the frame. In this manner frames comprising the outputs of 15 rows of sensitive elements are being considered. As a result, frame to frame correlation requires comparison and correlation between 15 rows of sensitive elements. Because higher frame sizes relative to the slice sizes result in higher sensitive element correlation, the use of higher frame to slice ratios is thus more likely to provide a valid authentication.

Each of the above descriptions of a slice and a frame are described with regard to the number of rows. The number of columns is presumed to be the entire number of elements in a given row. However, it is to be appreciated that the number of columns used in a slice may also be less than the entire number of elements available in a row of elements. For example, the columns at the edges of the sensor or in other portions of the sensor where noise or poor image collection occurs, may be excluded from the slice. The same is true for the removal of rows in a slice. This means that rows in portions of the sensor with poor image collection or high noise may also be excluded from the slice. As a result, the available portion of a given sensor may be reduced once low quality rows and columns are eliminated. In addition, the flexible concept of the slice and the frame may be varied based on the type of biometric sensor used and the relative motion between the biometric object and the biometric sensor. For example, there may be applications where the slice and the frame are defined by a number of columns of sensitive elements. In this case, each row of sensitive elements within the columns are sampled and used to determine the highest correlation frames between slices.

Various correlation strategies may be used to reconstitute a complete image of a biometric object from the successive partial images of the biometric object. For example, one correlation strategy compares the output signals of all the sensitive elements of two successive images for each possible case of overlapping of two images. However, the correlation methods of the present invention are superior to such trial and error based methods. Instead of randomly comparing all of the output signal data in an entire partial image, only a small portion of the data—a frame of data—is compared. Rather than rely on tenuous assumptions, such as constant swipe speed, embodiments of the methods of the present invention operate independent of swipe speed and as such are more accurate than systems that approximate or assume constant swipe speeds or fail to consider swipe speed during image reconstruction.

Swipe Reconstruction and Slice to Slice Correlation

In a swipe method, a finger is slid over an image capture window of a sensor 14. The sensor generally has the width of the finger but the height may be much smaller relative to the finger. The sensor captures multiple sub-images or slices of the fingerprint as it slides over the sensor. To reconstruct a complete fingerprint, the rate of capture of the sub-images or slices must be high enough to capture sufficient slices to reconstruct the fingerprint. Since the swipe speed can be variable, some mechanism is needed to determine how to seamlessly reconstruct the complete image from the collected slices. An optimized system would result in no gaps of missed image area nor would there be any redundant areas of image data.

The methods of the present invention relate to image reconstruction methods used in aerial and satellite imaging known as image registration. Image registration is performed using two pieces of information. The first is the knowledge of which sub-image or slice is overlapping another. The second relates to the overlap between the two slices. In this method, adjacent slices are correlated to determine the overlap of one upon the other. When the overlap is determined, the slices are joined by positioning them based upon the common overlap. For fingerprint swipe reconstruction, adjacent slices are known because the sequential capture of slice images corresponds to the sequential passage of the swiping finger. If the capture rate is high enough to assure overlap between adjacent slices, the exact placement of one slice upon another can be determined by correlating the adjacent slice areas.

Correlation for image registration is usually a computationally expensive operation. Generally, for a two dimensional biometric array, one would test for image overlap for various translations in both the x-axis and y-axis. Since a finger generally swipes in one direction across the sensor, correlation may only correlate a single axis of sensor data over different shifts from one slice to the next. Consider a slice to have rows in y and columns in x. In this example, the y-axis is parallel to the swipe direction and the x-axis is perpendicular to the swipe direction. Therefore, the finger moves some distance yₛ for each slice capture. This is called the shift. If the slice window height is Wₕ and if yₛ<Wₕ then there will be overlap, yₒ, where yₒ=Wₕ−yₛ.

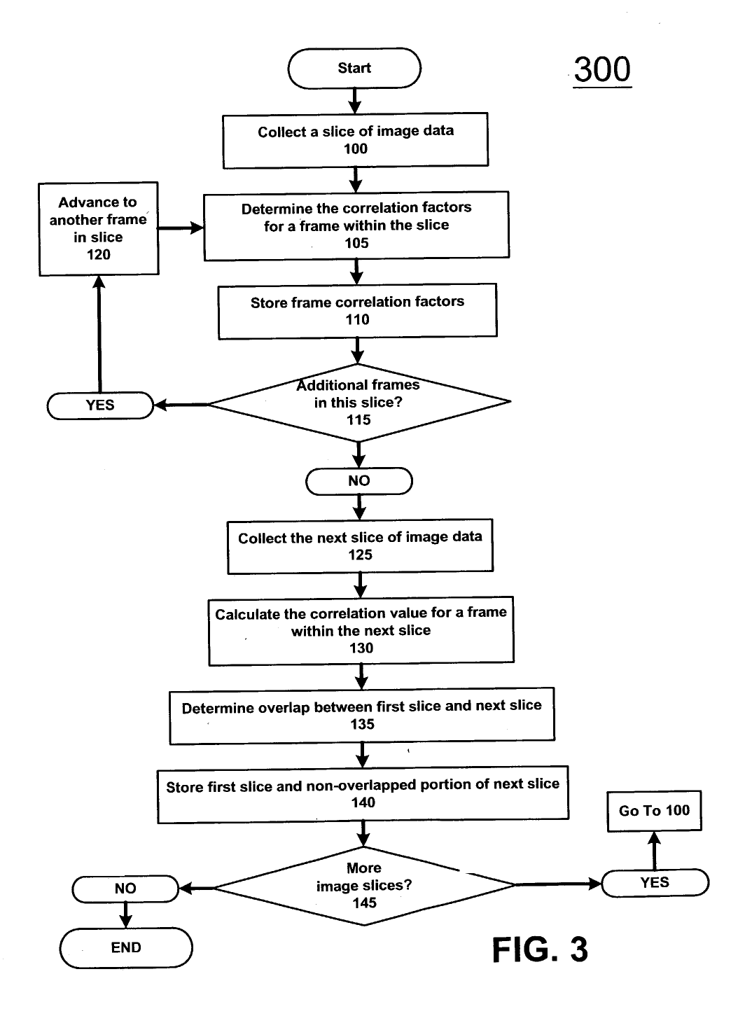

Turning now to FIG. 3, one method of determining the overlap between adjacent partial biometric object images can be better appreciated. FIG. 3 is a flow chart of a correlation method 300 used by a biometric sensor system as described in FIG. 1 for example, and executed by computer readable code to identify the overlapping portion of adjacent partial biometric object images. For example, the same will be described whereby the biometric object is a finger. First, as described above, define a slice and a frame for the image data to be processed. Once the slice and the frame are determined, the values are held by a software program, within system hardware or otherwise maintained by the system used to execute the image processing methods.

Next, as is typical in a swipe recognition system, a biometric object, such as a finger, for example, is moved across the sensor. As the finger moves across the sensor, a stream of image data is collected. In step 100, a slice of image data is collected by the system. In this step, the output of each of the sensitive elements in the defined slice is collected to form a slice of image data. This slice of image data will contain some number of sensitive elements.

Next, according to step 105, determine the correlation factor for the frames within the collected slice. For example by way of illustration and not limitation, consider an image sequence processed using a slice comprising 36rows and 256 columns and a frame comprising 6 rows and 256 columns. The first frame considered would include rows 1-6. According to step 105, determine the correlation factor for the sensitive elements within this frame. The correlation factor could be any of a wide variety of mathematical and/or statistical calculations used to quantitatively compare the various sensitive element outputs within a frame. In the example that follows, averages and deviations from those averages are used to determine frame to frame correlation. The correlation factors for rows 1-6 would be stored in computer readable memory for later processing (step 110).

The decision point 115 would be YES because there would be another frame of image data since only the first frame comprising the outputs from the sensitive elements in rows 1-6 has been processed. At step 120, the frame processed would advance to consider the data from the sensitive elements in rows 2-7. The process would continue thus to determine the correlation factors for rows 2-7 (step 105), store those correlation factors (step 110) answer YES to decision step 115 and advance again (step 120) to the next frame comprising rows 3-8. This process of selecting another frame and calculating the correlation factors continues until all the frames in the first slice have been processed and the correlation factors for each of the frames determined.

Before describing the remainder of method 300, consider first that the steps above describe advancing one row in step 120 so that there exists only one non-overlapping row between adjacent frames. Said another way there is only one new row of image data in the next frame. Such a small advancing step could result in finer image generation and greater probability for genuine authentication as well as increased anti-spoof capabilities. Using again the example of a 36 row slice and a 6 row frame, the first frame could include rows 1-6 and the next frame could include rows 3-8. In this case the overlap between the first and second frames of the slice includes 4 rows of image data. The frame to frame advance step may advance one row at a time or several rows at a time until the sensitive element outputs for all the frames within a slice are considered. Between the two overlap conditions of adjacent frames having only one row different and only one row in common other advancement intervals may be used and are within the scope of the invention. For example, the advance step may progress at a multiple of the frame row size. For example, consider a frame size of 6 rows and an advance step of 3 then the advance step will be at a half frame advance interval. Other fractional frame advance intervals are also possible and are considered within the scope of the present invention.

Returning to method 300. Next, at step 125, collect the next slice of image data. Determine the correlation factors for a frame of data within the next slice (step 130). Next, at step 135, determine where the first slice and the next slice overlap by identifying the highest correlation between the frame from the next slice and a frame from the first slice. The frame of the first slice with the highest correlation to the frame of the next slice will identify where the slices of image data overlap.

Next, at step 140, store the image data in computer readable memory. In general, the stored image includes the first slice and the non-overlapped portion of the next slice. Shift is a term commonly used to describe the non-overlapping or new image data between slices of image data. A resultant image of the two slices S1 and S2 could be an image coming from the first slice image S1 and that portion of slice S2 that is non-overlapping—or the shift—of S2. Referring to FIG. 1, the resultant image is kept in the memory 22 of the computer system 12. The resulting images from subsequent slice-to-slice comparisons are added to this first resulting image to reconstitute the fingerprint image. As will be discussed in greater detail below, the shift of the next and subsequent slices may be stored directly in memory or further processed before storing, such as, to remove stretch.

At step 145, determine whether additional image slices are to be processed. If more image slices are available, the answer in step 145 is “YES” and then return to step 100 and determine slice-to-slice overlap as detailed above. If all slice images for a given fingerprint have been evaluated and the slice-to-slice overlap determined, then the answer in step 145 is “NO” and the process ends. The final stored image may have additional image processing as described below or may be stored and utilized as collected in any of a variety of authentication programs and procedures.

While described above in step 120 with regard to advancing the frame in a single direction or axis, it is to be appreciated that embodiments of the present invention may also be applied to multi-dimensional correlation schemes. The above examples describe how embodiments of the invention may be applied to slices and their frames utilizing rows of sensitive elements and swipe motion that is generally perpendicular to those rows. Embodiments of the methods of the present invention may also be used to determine slice/frame correlation in two axes. For example, a process 300 of FIG. 3 could include within the frame correlation factor determination step 105 the determination of a multiple axes frame correlation factor. For example, a multiple axes frame correlation factor may include determining the x-axis correlation factors (for example, row correlation factors) and then the y-axis correlation factors (for example, column correlation factors). In a multiple axes correlation techniques, the comparison steps would also be modified as needed to include comparison calculations for each axis. Thus, embodiments of the frame and slice correlation methods for image reconstruction of the present invention may be advantageously applied to reconstitute outputs from biometric sensors producing multidimensional outputs, including two and three dimensional outputs.

Returning to process 300 of FIG. 3, various correlation strategies may be employed to determine which of the frames of the first slice has the highest correlation to the selected frame of the next slice. These correlation strategies are executed upon information from steps 105 and 130 and evaluated in step 135. One exemplary correlation method will be described now in relation to an illustrative slice comprising 36 rows and 256 columns of sensitive elements and an illustrative frame comprising 6 rows and 256 columns. In this illustrative method, correlation factors are based upon the deviation of the sensitive element outputs in each of the columns within a frame as described below.

First, calculate a column sum for each column in the given frame. The column sum is obtained by adding all signal output values for each sensitive element in a given column. Second, calculate the average value per column. The average value per column is calculated by adding all of the column sum values and dividing by the number of columns. Third, calculate the deviation per column. The deviation per column is the difference between a column sum for each column and the average value per column. These three steps are performed for every column of every frame in a slice. As a result, each frame within a slice will have a deviation per column value for each column within the frame. In this example, the frame correlation factors are the deviation per column values.

The deviation per column value is used, for example, in step 135 to identify the highest correlation between a frame of the first slice and the selected frame of the next slice in the following manner. First, compare the deviation per column values of the first frame of the first slice to the selected frame of the next slice. The between frame comparison is conducted column by column. For each column, determine the difference between the deviation per column values. After every column in the frame has been considered, sum all of the difference between the deviation per column values. Thus, after a frame of the first slice is compared to the selected frame of the next slice, a number is calculated that is the sum of the difference between the deviation per column values. After the above steps have been performed between each column of each frame of the first slice and each column of the selected frame of the next slice, the values of the sum of the difference between the deviation per column are compared. The frame within the first slice with the smallest value of the sum of the difference between the deviation per column value has the highest correlation to the selected frame of the next slice. Once the highest correlation frame in the first slice is identified, the overlap and shift between the first slice and the next slice is known.

Knowing which of the frames of a given slice has the highest correlation has several uses. For purposes of discussion, consider again the 36 row by 256column slice and the 6 row and 256 column frame. There are 31 frames in a given slice, each frame comprising six rows. The frame 1 includes rows 1-6, the frame 2 includes rows 2-7 and so forth up to the frame 31 that includes rows 31 to 36.

Referring to FIG. 1, consider now the flow of partial images of the fingerprint 52 of a finger 53, at successive points in time during a relative shift of the finger 53 on the sensor 14. The partial images are transmitted via the bus 26 and interface 16 as the processing inputs of the microprocessor 18 comprising random-access memory and a read-only memory containing a processing algorithm that enables the reconstruction of the complete image of the fingerprint 52 of the finger 53 as well as the authentication of this fingerprint.

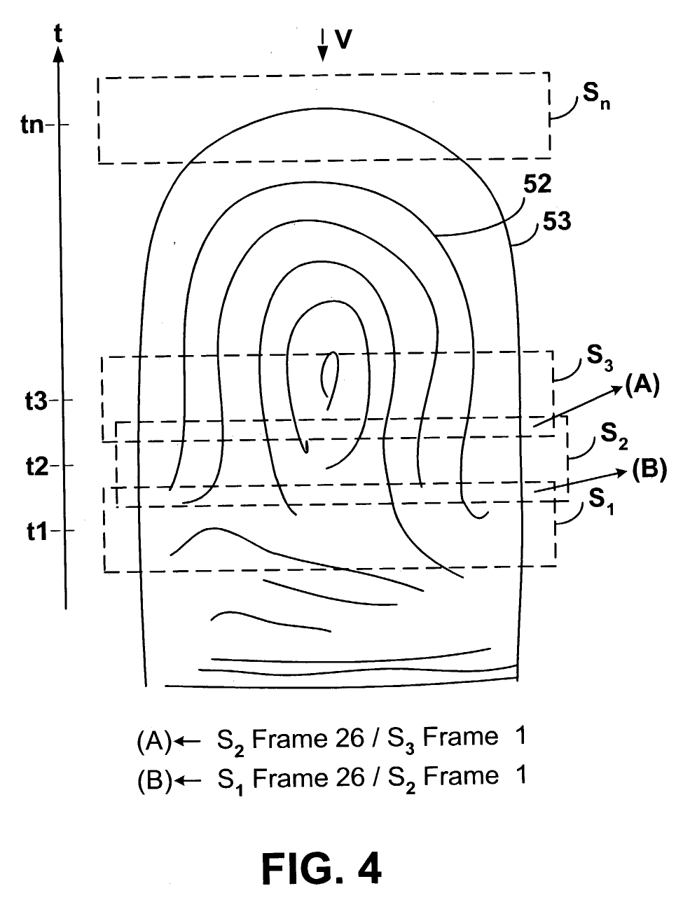

Turning now to FIG. 4, consider the finger 53 and its fingerprint 52 as the finger 53 slides across the rows of sensitive elements 200 of the sensor 14 in the direction V. The different positions at the instants t1, t2, t3, . . . , tn of the slice of image data collected by the sensor 14 during the finger's relative shift are shown in dashes. The slice is a predefined number of rows and columns of sensitive elements. A frame size relative to the slice size has also been defined. For purposes of discussion, each slice will have 36 rows of sensitive elements, each frame 6 rows. The collected outputs of the sensitive elements within the sensor generates the successive image slices S1, S2, S3, . . . , Sn at the respective instants t1, t2, t3, . . . , tn. In this figure, the speed of the finger across the sensor is such that at least one image slice partially overlaps the next one.

Let the initial time t1 be taken as the instant of reading of the first slice image S1 of the fingerprint 52. The next slice image S2 of fingerprint 52 is taken by the sensor at time t2. Next, at time t3 slice S3 is taken by the sensor and so forth to sampling time interval tn and the collection of slice Sn.

The slice images S1, S2, S3 . . . Sn are transmitted to and processed by the microprocessor 18 and stored in memory 22. All of the slices may be collected and then processed or slices may be processed as collected. An algorithm located in the memory 22 performs operations for processing of the slice images according to FIG. 3. These operations, described in greater detail above with regard to FIG. 3, are used to find overlapping portions between adjacent slice images S1, S2 and S2,S3 and so forth. Referring to FIGS. 3 and 4 together, S1 is collected at step 100. The correlation factors for the frames within slice S1 are determined (steps 105, 115 and 120). The next slice (S2) image data is collected (step 125). Correlation factors for a frame within slice S2 are determined. (step 130). The correlation factors of the frames of slice S1 are compared to the correlation factors of a frame of slice S2 to determine overlap between slices S1/S2. In this example, frame 1 of slice S2 was used to determine overlap. As illustrated in FIG. 4, frame 1 of slice S2 is used to compare to the frames of slice S1. In this example, slice S1 frame 26 had the highest correlation to slice S2 frame 1. As a result, the reconstituted image illustrated in FIG. 4 has slice S2 frame 1 correctly overlapped with slice S2 frame 26. Once the best correlation or the optimum position of overlapping of slices S1 and S2 is complete (step 140), the operation will be recommenced with the next images S2 and S3 (step 145). The slices up to slice Sn are processed according to the process 300 until the fingerprint 52 is completely reconstituted.

UNSTRETCH IMAGE

Another consideration when collecting partial biometric object data from a swipe collection process is stretch. Stretch refers to the apparent expansion or stretching of the biometric object data as a result of the speed of the biometric object over the sensor and the responsiveness of the sensor. Consider an example where the biometric object data is a fingerprint from a finger. If a collected fingerprint image from a swipe sensor is to be compared or authenticated against an enrolled image from a stationary finger, then the finger movement and resulting expansion of the print image must be considered before authentication. One possible solution would be for the enrolled fingerprint data to be collected at various swipe speeds and then ask the user to replicate some or all of the swipe speeds during the authentication process. The collected fingerprint image would not then be reconstituted into its stationary shape but would rather use an appropriate image processing algorithm to authenticate a collected stretched image. Such an authentication process would not require the removal of stretch but would rather utilize stretch or finger speed induced image variation to advantage as part of the authentication process. Other authentication processes are also envisioned that utilize stretched partial images for authentication.

A more common problem in the use of swipe sensors is that the enrolled fingerprint data is collected from a static finger or other enrollment methods that result in an unstretched image. As such, there is a need for removing stretch from a captured swipe image so that the captured images will be about the same size as enrolled images and valid comparison operations can occur.

In general, the apparent lengthening or stretch of an image is related to a hardware factor and a finger movement factor. The hardware factor relates to the response time and delays inherent in the systems used to collect image data. The hardware factor includes, for example: the response time of the sensitive elements in the image capture sensor; the type, size and number of sensitive elements used; the number of sensitive elements considered as part of a frame or slice; the time required to convert a sampled analog signal to digital data; the software methods used to collect, process and store the sensitive element outputs; the time period between sampling image data; the efficiency of the algorithm for processing the partial images coming from the sensor in order to reconstitute the full image; and other factors related to the processing, storing and transferring image data. The hardware factor may also be considered in view of image grab time and sampling frequency. The grab time refers to the time period required for a given image capture system to collect a slice of image data. All of the hardware, software and system considerations outlined above will contribute to the time it takes to collect output signals from each of the sensitive elements in a frame. The other consideration is the slice sampling interval. The slice sampling interval refers to the amount of time between collecting the output of the last sensitive element or pixel of a first slice and collecting the output of the first sensitive element of the next slice.

Based on the information above, a hardware stretch factor is defined as the ratio of the grab time or time to sample one slice of data to the sum of the grab time and the slice-sampling interval. As such, the hardware stretch factor is a unitless number with a value of less than 1.

The finger movement factor relates to the speed that the finger to be imaged passes over the sensitive elements. In general, the faster a finger moves across the sensitive elements the greater the image stretch. This factor may be determined based on a comparison between two adjacent slices of image data where the correlation has been identified. As described above, once two slices have been correlated the overlapping frames and rows are known. Using this information, it is possible to determine the ratio of the shift or number of rows between the two slices that do not overlap to the number of rows in a slice. For example, using the same frame and slice size described above, consider two examples. In the first example, a high finger speed and high shift example where there are 32 rows of the 36 rows in the slice that do not overlap. In this example, the ratio would be 32 divided by 36 or 0.889. In the second example, a low finger speed and low shift example where there are only 8 rows of the 36 rows in the slice that do not overlap. In this example, the ratio would be 8 divided by 36 or 0.22. This finger movement ratio is then multiplied by the hardware stretch factor to result in the overall unstretch factor.

For two examples of the overall unstretch factor calculation again consider the two finger speed examples above in an image processing system with a determined hardware unstretch factor of 0.5. In the first example, the high finger speed/high shift example where 32 rows of the 36 rows in the slice that do not overlap (ratio of 0.889) and a hardware factor of 0.5 would result in an overall unstretch factor of (0.889)(0.5) or 0.445. In the second example, the low finger speed/low shift example where 8 rows of the 36 rows in the slice that do not overlap (ratio of 0.22) and a hardware factor of 0.5 would result in an overall unstretch factor of (0.22)(0.5) or 0.11.

The overall unstretch factor may be used to determine how many rows of image data should be removed to compensate for stretch effects or, in other words, unstretch the collected image. The number of rows to be removed from the stretch image is determined by multiplying the overall unstretch factor by the shift. For example, using the same frame and slice size and examples described above. In the first example, a high finger speed and high shift example where there are 32 rows of the 36 rows in the slice that do not overlap. In this case the shift is 32 rows. From above, the overall unstretch factor in the high speed/high shift case is 0.445. Thus, shift times overall unstretch factor or 32 rows times 0.445 is 14.24 or 14 rows to be removed to compensate for stretch. In the second example, a low finger speed and low shift example where there are only 8 rows of the 36 rows in the slice that do not overlap. In this case the shift is 8 rows. From above, the overall unstretch factor in the low speed/low shift case is 0.22. Thus, shift times overall unstretch factor or 8 rows times 0.22 is 1.76 or 2 rows to be removed from a given shift to compensate for stretch. As to be expected from these two examples, it is shown that in the case of high finger speed more rows of image data needs to be removed to compensate for image stretch.

Once the number of rows to be removed is determined, row removal to compensate for stretch may be accomplished in a number of ways. The total number of rows may be removed in an unweighted block of rows from a specified position in the shift. For example, the total number of rows may be removed from the rows of the shift nearest the overlapping frame. Alternatively, the total number of rows may be removed from the rows of the shift furthest from the overlapping frame or at some intermediate point in the shift.

In one preferred method of row removal to compensate for slice, the rows to be removed are distributed across the shift. In the high shift example the shift is 32 and there are 14 rows to be removed. Dividing the shift by the number of rows provides a way of evenly distributing the row removal or an interval of row removal. In this example, the 14 rows to be removed from the 32-row shift is accomplished by using an interval of 2 or by removing every 2 rows. This is calculated by 32 rows divided by 14 rows to remove results in 2.29 or approximately every 2 rows. In the low shift example the shift is 8 and there are 2 rows to be removed. The interval is calculated by dividing the shift by the number of rows so as to distribute the row removal. In this example, the 2 rows to be removed from the 8 row shift results in an interval of four or by removing every fourth row.

The above examples consider uniform application of the row removal interval. Fractions of the row removal interval may also be combined with full removal intervals as another way of row removal distribution. For example, the first row removal may occur at one half the full interval, thereafter, rows are removed at full interval until the last row removal which is accomplished at half interval. The half interval need not be applied only at the beginning of the shift but could also be applied to the middle and end of the shift or, alternatively, to the beginning and middle of the shift. Although described with a half interval removal factors, other fractional removal factors, such as third, quarter and so forth are envisioned and may also be used and applied to the shift as described above with regard to the half interval.

In addition to the above considerations, row removal to account for stretch could also be non-uniformly applied to a given shift depending upon swipe speed. Consider an example where swipe speed is high. In this case, the image stretch in a given shift will be greatest in that portion of the shift image furthest away from the overlapping frame. In such as case, the row removal to account for stretch should be applied to the portion of the shift where stretch is likely greatest, for example, in that portion of the shift furthest from the overlapping frame.

Once the number of rows to be removed from the shift to compensate for stretch have been removed according to any of the methods described above, the remaining rows of data are condensed and then stored into the image buffer. The process repeats for the series of slices of image data until a full fingerprint image is assembled and then measured against the enrolled finger.

As illustrated by the above examples, there may be occasions when the stretch row removal may include some partial row or otherwise induce a rounding error in the number of rows removed. As a result of the rounding error, more or fewer rows may be removed than are needed. These rounding errors could be collected by the stretch software until some rounding error threshold value is reached. After the threshold rounding error is reached, the error could be factored into the overall stretch of the complete image or applied instead to a series of image slices.

Swipe Start and Stop Detection

The slice/frame reconstruction methods described above may also be used to advantage to determine swipe start and swipe stop. Accordingly, there is now added a piece of information for swiping that is not present in earlier touch capture and other swipe systems, that is the motion of the finger during the swipe. A start is detected as the beginning of motion of a finger across the sensor and the stop is detected as the absence of motion across the sensor. When it is determined that there is an image shift between two slices then the swipe has started. On the other hand, a stop is indicated when comparison of subsequent slices indicates no shift between them. Accordingly, the present method allows for slow swipe speeds or even pausing during swiping since swipe stop is not indicated when only a pair of slices indicates no shift. Instead, the present inventive method defines swipe stop as occurring when a threshold number of slices without shift have been detected. For example, the slice threshold for swipe stop, Tₛ, may be 20. This value indicates that if 20 or more slices are collected/compared without shift then a swipe stop event is determined.

Multiple Swipe Speed Detection and Adaptation

The method of reconstruction described above allows for a range of swipe speed from zero (stop) to maximum speed. Furthermore, it allows for an unlimited variation in swipe speed. This is important because a user should not be limited to an absolutely uniform action, especially since the finger may sometimes start and stop due to friction between the finger and the swipe sensor, or users may accelerate or decelerate finger speed during swipe. One of the key advantages of the present invention is the ability to capture swipe speed data in real time from each pair of image slices generated. The ability of the slice/frame correlation method of the present invention will now be described with regard to a variety of swipe speed conditions.

Uniform Swipe Speed Indication

As described above, FIG. 4 represents a constant swipe speed condition. Using the slice and frame correlation method described above with regard to FIG. 3, it can be seen that the swipe speed is constant since the first frame of the subsequent slice overlaps the same frame of the previous slice. As illustrated, frame 1 of S2 overlaps S1 at S1 frame 26; and S3 frame 1 overlaps S2 at S2 frame 26. Constant swipe speed is indicated because there is shift (a portion of the two slice images does not overlap) and the subsequent slice overlaps at a fixed frame position in relation to the previous slice.

“Too Fast” Swipe Speed Detection

The reconstruction methods described herein also enable “too fast” swipe detection. If the finger moves across the sensor at a speed that is too fast for the sensor to capture reconstructable images, then this will be detected by the fact that no slices overlap. In one case, the swipe speed will be so fast that there will be absolutely no correlation between adjacent slices. The measure of correlation will be small indicating that the swipe speed was too fast. In the second case, the shift will be calculated as the maximum shift speed plus one. This is the case for a shift that is close to but above the maximum shift speed. In this case the speed will also be indicated as too fast. The correct system response for this situation is for the system to alert the user to swipe again at a slower speed.

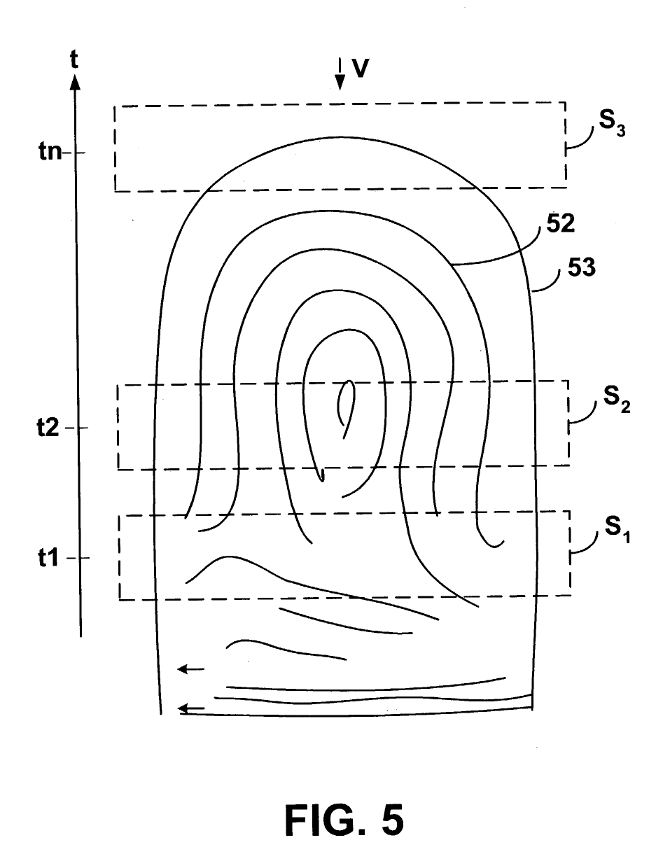

Referring now to FIG. 5, consider how the slice/frame correlation method of the present invention may be used to detect a “swipe too fast” condition. There are at least two methods for determining a “swipe too fast” condition. One method involves the use of a threshold slice/frame correlation value. The threshold slice/frame correlation value is a number used to determine that some valid overlap or correlation condition exists between two compared slices. The threshold slice/frame correlation value is specific to a particular biometric sensor system and is based upon several factors, such as, for example, the number of sensitive elements being compared, the mathematical and statistical techniques used to compare the sensitive element outputs, and the magnitude of the sensitive element outputs. In our example, where the correlation factor is related to the sum of the column deviation differences, a small number (low difference) would indicate high correlation. As such, the threshold slice/frame correlation value is expected to be a high value number that would thereby indicate a low probability of or no correlation between the compared slices.

Consider the following example. Slice S1 is collected and its frame correlation factors calculated, next slice S2 is collected and the correlation factors for a frame within slice S2 are calculated. However, when the frames of slice S1 are correlated to the frame of slice S2, the frame correlation values will exceed the threshold correlation value used to indicate that no overlap exists between slices S1 and S2. The correlation threshold value is a number above which the software will indicate that although a correlation value has been assigned mathematically, the correlation value is beyond that which is generated or associated with actual frame correlation values. In this case, when the calculated correlation value between two frames exceeds the correlation threshold value, then the software with declare that there is no overlap between adjacent slices or a “swipe too fast” condition.

Another method of determining a “swipe too fast” condition involves the use of a maximum allowable shift. Consider the following example. Slice S1 is collected and its frame correlation factors calculated, next slice S2 is collected and the correlation factors for a frame within slice S2 is calculated. However, when the frames of slice S1 are correlated to the frame of slice S2, the shift between slices S1 and S2 is known. If that shift is or is greater than the maximum shift allowed for a given sensor system, then the system would declare a “swipe too fast” condition exists. There are several acceptable methods to determine the maximum shift value. The maximum shift allowed between slices could be determined as simply using more than one frame of overlap between adjacent slices. In other words, the maximum shift would be the slice height minus the frame height. Consider an example where the heights are expressed as rows of sensitive elements and the slice is 32 rows and the frame 6 rows. In this example, the maximum shift would be 26 rows. If during the correlation process shift was determined to be at or near 26 rows, then a swipe too fast condition would be indicated.

Another method of determining the maximum shift is related to the slice and the frame as well as the size of the sensor elements themselves. The maximum shift allowed between adjacent slices depends on a number of factors such as the frame size, the slice size and the size of the individual sensitive elements. In the case where the biometric object swipes down an array perpendicular to the rows of the array, then the maximum shift is difference of the number of rows of the slice and the number of rows in the frame. That result is then multiplied by the width (row dimension) of the individual elements. As a specific example where the sensitive elements are pixels. Consider, for example, a specific sensor array having 300×256 pixels, a 32 pixel slice, a 6pixel frame, pixel elements that are 50 μm square, and an assumed acceptable finger speed of about 2 cm/sec. Such an arrangement would yield a 1.3 mm maximum shift. Using a sensor based maximum shift as above, frame to frame correlation values for slices S1/S2 resulting in shifts greater than 1.3 mm would indicate that no overlap exists between slices S1/S2. This method of determining maximum shift can be used to calculate maximum shift values for various types of biometric sensors and assumed swipe speeds.

Another benefit of the frame/slice correlation method of the present invention may be appreciated through reference to FIGS. 4, 6 and 7. In FIG. 4, the speed of the finger across the sensor is such that at least one image slice partially overlaps the next one. Because once frame overlap within each slice is determined, the speed or relative shift may be determined between every pair of slices. For example, FIG. 4 represents a nearly constant swipe speed or shift because slice S2 frame 1 overlaps slice S1 at frame 26 and slice S3 frame 1 overlaps S2 at frame 26 as well. Since each slice overlaps the previous slice at the same frame (e.g. frame 26), then the relative swipe slice to slice speed is constant.

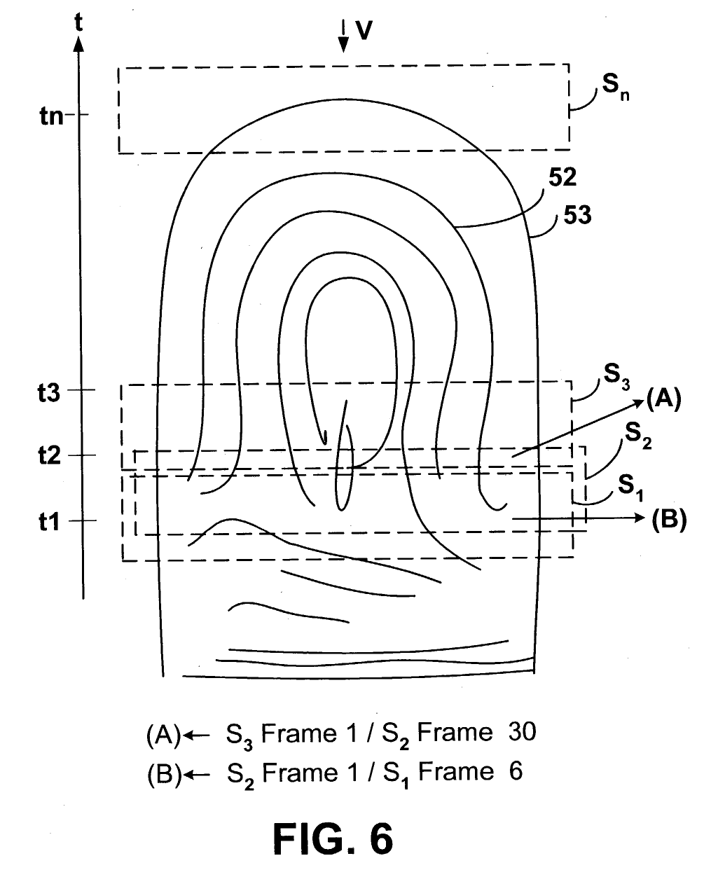

Referring now to FIG. 6, consider how the slice/frame correlation method of the present invention may be used to detect a changing slice to slice swipe speed condition. FIG. 6 illustrates increasing swipe speed. Slices S1, S2 and S3 are collected as finger 53 moves across sensor 14. Take for example, that when frames of slices S1 and S2 are correlated, frame 1 of slice S2 overlaps with frame 6 of slice S1. If a constant swipe speed was assumed, then one would expect that slice S3 frame 1 would overlap slice S2 at frame 6. However, because swipe speed is increasing from slice S2 to slice S3, frame 1 of slice S3 instead overlaps with slice S2 frame 30. As such, a processing system using an assumed constant swipe speed or that did not account for increases in swipe speed would introduce an image reconstruction error in the slices. Such errors may also lead to errors in the comparison between the reconstructed fingerprint image the enrolled fingerprint image.

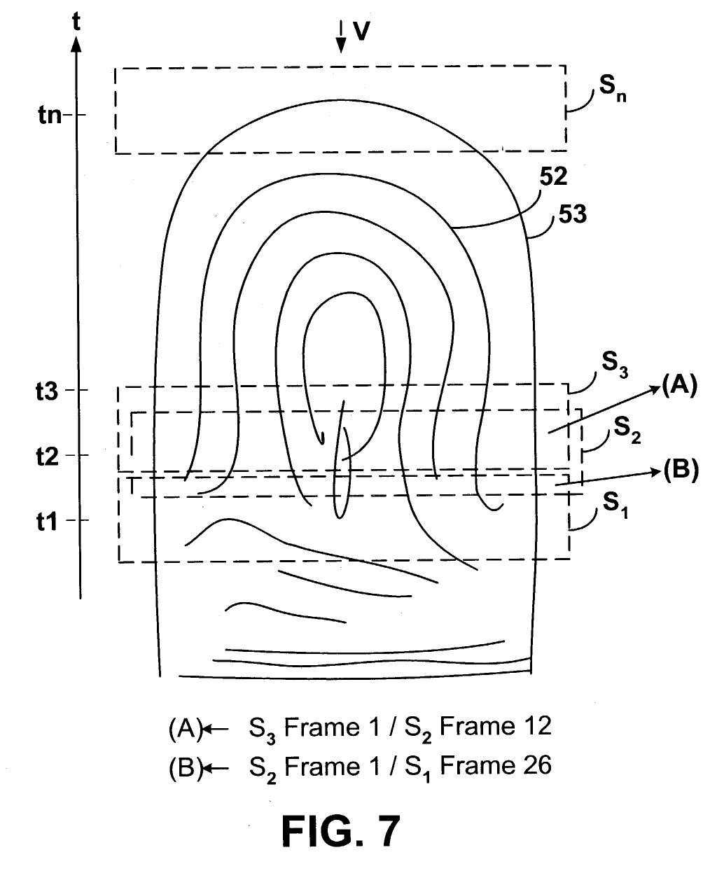

Referring now to FIG. 7, consider how the slice/frame correlation method of the present invention may be used to detect a changing swipe speed condition of decreasing swipe speed. As before, slices S1, S2 and S3 are collected as finger 53 moves across sensor 14. When frames of slices S1 and S2 are correlated, frame 1 of slice S2 overlaps with frame 26 of slice S1. If there was a constant swipe speed, then one would expect that slice S3 frame 1 would overlap slice S2 at frame 26. However, because swipe speed is decreasing from slice S2 to slice S3, frame 1 of slice S3 instead overlaps with slice S2 frame 12. As such, a processing system using an assumed constant swipe speed or that did not account for decreases in swipe speed would introduce an image reconstruction error in the slices. Such errors may also lead to errors in the comparison between the reconstructed fingerprint image the enrolled fingerprint image. For purposes of illustration, the constant, increasing and decreasing speed examples above have been described as indicating changes in swipe speed from slice to slice. While the methods of the present invention utilizing frame/slice correlation are capable of detecting such speed variations, it is more likely that, in use, swipe speed variation would occur over a number of slices. In any event, swipe speed variation is detectable using the methods of the present invention.

FIGS. 4, 5, 6 and 7 are provided to give a clearer view of the relative motion of the finger 53 with respect to the sensor 14. In each figure, the finger 53 is shown with the slice images S1, S2, S3 and Sn illustrated in a superimposed fashion that indicates the relative capture of each slice image with respect to the adjacent slice images and the finger movement. The operation of a biometric object image capture system would be the same in the case of a stationary finger and a moving sensor or more generally a mobile finger sliding on a mobile sensor. The parameter to be considered is the relative motion between the biometric object and the biometric sensor. In that regard, the swipe motion could be across columns of sensor elements rather than down rows of sensor elements. Embodiments of the image correlation methods of the present invention may be used to advantage regardless of the type of relative motion between object and sensor.

Spoof Finger Swipe Detection

Since swiping requires an action of the user, some characteristics of swiping can be measured and compared to those of the true user to determine if the swipe is from a true user or from a spoof finger or user.

For example, the swipe speed can be measured from the length of the fingerprint imaged divided by the swiping time beginning from finger placement to finger removal. The beginning position of the fingerprint over the imager and the final position on the fingerprint at which the user removes the finger can be measured. The width of the imaged fingerprint throughout the course of swiping can be measured. The medial axis (center line of the fingerprint) can be determined to determine if the user typically tilts the finger left or right of the center fingerprint core. Other characteristics that may be associated with the type of capture device can also be measured, for instance, electrical, optical or thermal characteristics of the finger can be recorded during the swipe.

For additional security dynamics of swipe capture, the system might request the user to vary swipe conditions to include specified user behavior. In this manner, not only is the user biometric data collected but the method of collecting that data may be varied to further improve security and deter spoof attempts. For example, the system may request the user vary the speed of swiping, for example, slow and fast. Each of the swipes performed at these speeds can be measured. Another example of altered swipe capture is where the system requests user alteration of swipe image capture termination. For example, the system may instruct the user to lift the finger “half way along” thereby terminating swipe image capture. In this condition, the system would record this arbitrary swipe image capture termination for comparison.

Similarly, the user might be asked to perform any of a wide variety of altered swipe conditions such as adjusting the attitude of the biometric object relative to the biometric sensor. For example, when a fingerprint is to be collected, the user might be instructed to use a tilted finger, left or right, or fingertip for swiping. Additionally, the user may be instructed to swipe across the sensor in a predetermined pattern relative to the sensor. For example, a user may be asked to swipe the left edge of a finger in a diagonal pattern across the sensor from upper left corner to lower right corner. Anti-spoof swipe variations may also be devised that combine several of the above mentioned variations to create a robust and unique collection of enrolled swipe data. Consider the following example. A user is enrolled with an initial standard swipe that comprises the middle of the finger at low swipe. The initial standard swipe could be any swipe condition but is the first swipe gathered from an unknown user to perform authentication. Next in the user enrollment process, the user is asked to perform a number of secondary enrolled swipes. These secondary enrolled swipes could include altered swipe conditions from those described above or envisioned by those of ordinary skill in the art. As a result, an enrolled user will have a enrolled swipe data file that contains a standard initial swipe and a number of secondary enrolled swipes. During a subsequent authentication procedure, an unknown user will perform a first swipe whereby the system will collect the image to compare with the standard initial swipe. Next, the system will request that the user perform one or several secondary swipes based upon the altered swipe conditions found in a randomly selected subset or the complete set of the secondary enrolled swipes. Thus, to succeed, an attempted spoof would be required to provide a matching image to the standard initial swipe. In addition, since the secondary image data could be one or many enrolled images from a wide variety of swipe images collected under altered swipe conditions, the attempted spoof faces the daunting task of having prepared spoof image data to correspond to a wide variety of secondary enrolled swipes. Embodiments of the anti-spoof method described above are particularly effective because of the randomness in selecting the secondary enrolled swipe for comparison coupled with the nearly limitless variation for producing altered swipe conditions to produce secondary enrolled swipe images. In addition, the unknown user could also be required to perform the same number of secondary swipes as were performed to generate and collect the plurality of secondary enrolled swipe images. For example, consider the case where the enrolled user has generated enrolled user data comprising a standard initial enrolled swipe image, and three secondary enrolled swipe images collected by three different swipe conditions, for example, finger tilt left, fingertip swipe and stop half way along the swipe sensor. In this example, an unknown user attempted to be authenticated as the enrolled user would also be required to perform four swipes corresponding to the four swipes described above. The anti-spoof element here is that the authentication software routine can select which of the available swipe images collected to compare. For example, the standard initial images may be compared along with the fingertip swipe only. In this manner, an attempted spoof is made more challenging because the attempted spoof is required to generate passable image data for all four different swipe conditions even though—unknown to the spoof—only two of the collected images were compared to the enrolled images for authentication.

The width, speed, and other sensor data for each of these alternative swipe conditions can be measured. Moreover, the swipe/frame correlation methods of the present invention may be used to advantage to gather and reconstruct the enrolled standard and secondary images and the collected images.

The results of these various altered swipe conditions comprises a vector of feature values that are recorded during the course of the swipe image capture process. The numerical values related to the altered swipe condition are compared against the original swipe “signature”. A swipe signature is a set of characteristics of the true user's finger or other biometric recorded as the user performs any or all of the variety of altered swipe conditions described above. The signature of the true finger can be the one initially enrolled or it can be the result of data collection for all image captures from the true user.

A comparison is made between values in the original signature and the values obtained from the captured image. If the differences are low, then the behavioral attributes of capture are considered similar to indicate the true user. In this case, the applied fingerprint is compared against the enrolled fingerprint and if they match, then verification is made. If the differences are high, then there is a possibility that the fingerprint is an attempted spoof. In this case, the system might reject the user outright or further checks might be requested of the user, such as enter a password known only to the user or to perform an additional image capture based upon another altered swipe condition.

The above examples and embodiments have described how embodiments of the present invention may be used to advantage with swipe based biometric sensors. It is to be appreciated, however, that embodiments of the present invention may also be used in biometric sensors where the biometric object and the sensor are stationary. Consider the example where the biometric sensor is smaller than the biometric object to be measured. In this example, the biometric object could be placed in a plurality of partially overlapped positions where a slice of image data is collected from each position. Thereafter, the slices of image data could be assembled using the frame/slice correlation methods described above to identify the proper overlap between adjacent slices. Once the frames are properly correlated, the full image of the biometric object could be reassembled and then compared to an enrolled object.

In a specific example, the biometric object could be a finger and the sensor used to collect fingerprint image data. The sensor could therefore be smaller than the finger thus enabling use of a sensor smaller than the biometric object to be measured. A user would place his finger on the sensor in a number of positions such that a slice of data is collected from each position. These various positions could follow any of a wide variety of patterns. For example, positions such as right side, middle, and left side could be used. The slice data from each position is then correlated using the frame/slice methods detailed above to identify the best correlation or placement of adjacent slices. Once the best overlap position is determined, then the collected images are compiled into a full fingerprint image and compared to an enrolled fingerprint image.

While the foregoing is directed to the preferred embodiment of the present invention, other and further embodiments of the invention may be devised without departing from the basic scope thereof, and the scope thereof is determined by the claims that follow.

We claim:

1. A method for reconstructing two overlapping images, comprising:
collecting a first slice of image data;
collecting a second slice of image data;
determining the correlation factors for a plurality of frames of image data within the first slice;
determining the correlation factors for a frame of image data within the second slice;
comparing the correlation factors from each of the plurality of frames of image data from the first slice to the correlation factors for the frame of image data from the second slice;
determining the frame within the first slice with the highest correlation to the frame from the second slice; and
positioning the first slice of image data relative to the second slice of image data based upon the location of the frame within the first slice with the highest correlation to the frame from the second slice.

2. The method according to claim 1 wherein the said image data is taken from a biometric object.

3. The method according to claim 2 wherein the biometric object is a fingerprint or a palmprint.

4. The method according to claim 1 wherein the steps of collecting a first slice of image data and collecting a second slice of image data are performed by collecting outputs from an array of sensitive elements in a biometric sensor.

5. The method according to claim 4 wherein the biometric sensor is a fingerprint sensor.

6. The method according to claim 1 wherein the step of determining the correlation factors for a plurality of frames of image data within the first slice further comprises the step of determining the deviation per column values for each column of sensitive elements within the frame.

7. The method according to claim 1 wherein the step of determining the correlation factors for a frame of image data within the second slice further comprises the step of determining the deviation per column values for each column of sensitive elements within the frame.

8. The method according to claim 1 wherein the step of comparing the correlation factors from each of the plurality of frames of image data from the first slice to the correlation factors for the frame of image data from the second slice further comprises the steps of:
determining the difference between the deviation per column values for each of the frames in the first slice to the deviation per column value for the frame of the second slice; and
calculating the sum of the difference between the deviation per column values.

9. The method according to claim 8 wherein the step of determining the frame within the first slice with the highest correlation to the frame from the second slice further comprises the step of:
comparing the sum of the difference between the deviation per column values to find the frames with the smallest value of the sum of the difference between the deviation per column values.

10. A method for reconstructing fingerprint images from a fingerprint sensor, comprising the steps of:
collecting a first slice of fingerprint image data from a first plurality of sensitive element outputs;
collecting a second slice of fingerprint image data from a second plurality of sensitive element outputs;
reconstructing the fingerprint image by positioning the first slice relative to the second slice based on comparing the correlation factors of the frames of the first slice to the correlation factors of a frame in the second slice.

11. The method according to claim 10 wherein the fingerprint image is generated by swiping a finger along a fingerprint sensor.

12. The method according to claim 10 wherein the fingerprint image is generated by placing a finger on a fingerprint sensor in a plurality of positions to generate a complete fingerprint image.

13. The method according to claim 10 wherein the number of sensitive elements in each of the frames of the first slice is less than half the number of sensitive elements in the first plurality of sensitive elements.

14. The method according to claim 10 wherein the number of sensitive elements in each of the frames of the first slice is more than half the number of sensitive elements in the first plurality of sensitive elements.

15. The method according to claim 10 wherein the number of sensitive elements in the first plurality of sensitive elements is the same as the number of sensitive elements in the second plurality of sensitive elements.

16. The method according to claim 10 wherein the step of comparing the correlation factors of the frames compares the frames in one dimension.

17. The method according to claim 10 wherein the step of comparing the correlation factors of the frames compares the frames in two dimensions.

18. The method according to claim 10 wherein the correlation factor for a frame of image data is based upon the comparison of outputs from columns of sensitive elements arranged in a biometric sensor.

19. The method according to claim 10 wherein the correlation factor for a frame of image data is based upon the comparison of outputs from rows of sensitive elements arranged in a biometric sensor.

20. The method according to claim 10 wherein the correlation factor for a frame of image data is based upon comparison of the outputs from the rows and the outputs from the columns of sensitive elements arranged in a biometric sensor.

21. A method for compensating for stretch in biometric object data collected from a swipe sensor, comprising the steps of:
collecting two slices of image data;
determining the shift between the slices by comparing frames within the slices;
determining the amount of stretch in the collected image data; and
adjusting the collected image data to compensate for the amount of stretch.

22. The method according to claim 21 wherein the step of determining the amount of stretch in the collected image data further comprises the steps of:
determining a hardware stretch factor;
determining a finger swipe speed stretch factor;
applying the hardware stretch factor and the finger swipe speed stretch factor to the shift to determine the amount of image stretch.

23. The method according to claim 21 wherein the step of adjusting the collected image data to compensate for the amount of stretch further comprises the step of removing some of the shift image data.

24. The method according to claim 23 wherein the step of removing some of the shift image data further comprises removing a plurality of rows of image data from the shift image data.

25. The method according to claim 23 wherein the step of removing some of the shift image data introduces a rounding error into adjusted collected image data.

26. The method according to claim 25 wherein the introduced rounding error is collected and applied to the adjusted collected image data.

27. The method according to claim 24 wherein the plurality of rows of image data removed from the shift image data are uniformly removed from the shift image data.

28. The method according to claim 24 wherein the plurality of rows of image data removed from the shift image data are non-uniformly removed from the shift image data.

29. The method according to claim 21 wherein the step of adjusting the collected image data to compensate for the amount of stretch further comprises the step of removing a plurality of rows of shift image data that portion of the shift image data furthest from the overlapping portion of the collected slices of image data.

30. The method according to claim 21 wherein the step of adjusting the collected image data to compensate for the amount of stretch further comprises the step of removing a portion of shift image data relative to the amount of stretch in the shift in the portion of the shift image data where the most image stretch occurs.

31. The method according to claim 22 wherein the step of adjusting the collected image data to compensate for the amount of stretch further comprises the step of determining an interval of image removal based upon the shift image data and the amount of image stretch.

32. The method according to claim 31 wherein the step of adjusting the collected image data to compensate for the amount of stretch further comprises the steps of:
removing a portion of the shift of image data based on a fraction of the image removal interval; and
removing a portion of the shift of image data based on the full image removal interval.

33. A method according to claim 32 wherein the fraction of the image removal interval is about half of the image removal interval.

34. A method for detecting swipe start on a swipe sensor, comprising the steps of:
collecting slices of image data;
comparing the collected slices of image data to detect an image shift between two slices; and
determining that swipe has started when an image shift is detected.

35. The method according to claim 34 wherein the step of comparing the collected slices of image data to detect an image shift between two slices further comprises the steps of:
determining correlation factors for a plurality of frames within one slice;
determining correlation factors for a frame within another slice;
determining the shift between the one slice and the another slice by comparing the correlation factors for each of the plurality of frames within the one slice to the correlation factors for the frame within the another slice.

36. A method for determining when swiping has stopped in a swipe sensor, the method comprising the steps of:
collecting multiple slices of image data from a biometric sensor;
comparing adjacent slices within the multiple collected slices of image data to detect an image shift between two slices; and
determining that swiping has stopped when there is no image shift detected before a threshold number of image slices is collected.

37. A method for detecting a swipe too fast condition on a swipe sensor, comprising the steps of:
collecting slices of image data from a swipe sensor;
attempting to correlate any one of a plurality of frames of image data from within one slice to a frame of image data within an adjacent slice; and
determining that there is a swipe too fast condition when none of the plurality of frames of image data from the one slice correlates to a frame of image data from an adjacent slice.

38. A method of authenticating fingerprints in a swipe fingerprint system, the method comprising the steps of:
creating an enrolled fingerprint image data file for a true user by instructing the user to swipe at several different speeds;
collecting slices of fingerprint image data while the true user swipes at several different speeds;
instructing an unknown user claiming to be the true user to swipe at several different speeds;
collecting slices of image data as the unknown user swipes at different speeds; and
determining whether the unknown user is the true user by comparing the slices of image data collected from the true user at several different swipe
speeds to the slices of image data collected from the unknown user at several different swipe speeds.

39. A method for authenticating a user based on biometric image data, comprising the steps of:
collecting a standard initial enrolled swipe image from an enrolled user;
collecting a secondary enrolled swipe image from an enrolled user;
collecting a standard initial swipe image from an unknown user;
collecting a secondary enrolled swipe image from an unknown user; and
determining whether the unknown user is the enrolled user by comparing the standard initial enrolled swipe image from an enrolled user to the standard initial swipe image from an unknown user and comparing the secondary enrolled swipe image from an enrolled user to the secondary enrolled swipe image from an unknown user.

40. The method according to claim 39 wherein the steps of collecting a secondary enrolled swipe image from an enrolled user and collecting a secondary enrolled swipe image from an unknown user further comprise the collection of image data from altered swipe patterns.

41. The method according to claim 40 wherein the altered swipe patterns are selected from or are combinations from the group of swipe patterns consisting of: swipe fast, swipe slow, swipe with finger tilt left, swipe with fingertip, swipe and stop half way along the swipe sensor, and swiping a pattern across the sensor.

42. The method according to claim 39 wherein the steps of collecting a secondary enrolled swipe image from an enrolled user and collecting a secondary enrolled swipe image from an unknown user further comprise the step of collecting a plurality of secondary swipe images from a variety of altered swipe conditions.

43. The method according to claim 42 wherein the step of determining whether the unknown user is the enrolled user further comprises the step of comparing less than all of collected plurality of enrolled secondary images to less than all of the collected unknown user secondary images.
